(19) United States
(12) Patent Application Publication
(10) Pub. No.: US 2025/0358689 A1
(43) Pub. Date: Nov. 20, 2025

(54) USER CONSENT PREFERENCE TRANSMISSION AND DETERMINATION METHODS, CONFIGURATION DETERMINATION METHOD, AND POSITION INFORMATION REPORTING METHOD

(71) Applicant: Beijing Xiaomi Mobile Software Co., Ltd., Beijing (CN)

(72) Inventor: Wei LU, Beijing (CN)

(73) Assignee: Beijing Xiaomi Mobile Software Co., Ltd., Beijing (CN)

(21) Appl. No.: 18/869,425

(22) PCT Filed: May 31, 2022
(86) PCT No.: PCT/CN2022/096500

§ 371 Date: Nov. 26, 2024

(51) Int. Cl. H04W 36/00; H04W 4/02; H04W 76/27

(52) U.S. Cl. CPC H04W 36/0033; H04W 4/025; H04W 76/27

(57) ABSTRACT

A system and methods for managing user consent preferences during terminal handovers between service networks are disclosed. A first core network in a first service network determines to hand over a terminal to a second service network, transmitting the terminal's user consent preference, which indicates whether the terminal consents to report location information. The user consent preference may be generic across locations or determined through other means if not received, including retrieval from a unified data management function (UDM) of the terminal's home network. The second core network processes and stores the consent preference and communicates it to the second base station as part of the handover process. The second base station configures the terminal for location reporting based on the user consent preference and communicates with the terminal accordingly. Communication devices implementing these methods enable seamless and compliant handover operations while respecting user privacy preference.

### CROSS REFERENCE TO RELATED APPLICATIONS

This application is a US National Phase of a PCT Application No. PCT/CN2022/096500 filed on May 31, 2022, the entire contents of which are incorporated herein by reference in their entirety.

### TECHNICAL FIELD

The present disclosure relates to the field of communication technology, in particular to a user consent preference transmitting method, a user consent preference determining method, a configuration determining method, a location information reporting method, a consent preference transmitting apparatus, a user consent preference determining apparatus, a configuration determining apparatus, a location information reporting apparatus, a communication device, and a computer-readable storage medium.

### BACKGROUND

In non-terrestrial networks, a terminal and a base station can communicate through an aerial device such as a satellite. Since the terminal performs communications within a coverage range of the satellite, and the coverage range of the satellite is extremely large, it is generally difficult for the base station to determine the location information of the terminal in this case. When the location information of the terminal needs to be obtained, the terminal needs to report terminal location information.

However, as terminal location information involves the privacy of the terminal, not all terminals agree to report terminal location information. Therefore, the base station first determines, based on user consent preference of the terminal, whether the terminal consents to report terminal location information.

So, in the case of a handover of the terminal from a first service network to a second service network, how to provide the user consent preference of the terminal to a network device in the second network is an urgent technical problem to be solved.

### SUMMARY

In view of this, the embodiments of the present disclosure propose a user consent preference transmitting method, a user consent preference determining method, a configuration determining method, a location information reporting method, a consent preference transmitting apparatus, a user consent preference determining apparatus, a configuration determining apparatus, a location information reporting apparatus, a communication device, and a computer-readable storage medium to solve technical problems in related arts.

According to the first aspect of the embodiments of the present disclosure, a method for transmitting user consent preference is proposed, the method is performed by a first core network in a first service network, and includes: determining that a terminal handovers from a first base station in the first service network to a second base station in a second service network; and transmitting user consent preference of the terminal to a second core network in the second service network; where the user consent preference is configured to indicate whether the terminal consents to report terminal location information.

According to the second aspect of the embodiments of the present disclosure, a method for determining user consent preference is proposed. A second core network performs the method in a second service network, and includes: receiving user consent preference of a terminal transmitted by a first core network in a first service network, where the terminal handovers from a first base station in the first service network to a second base station in the second service network, and the user consent preference is configured to indicate whether the terminal consents to report terminal location information; and determining, in response to determining that the user consent preference is not received from the first core network, the user consent preference through other means.

According to the third aspect of the embodiments of the present disclosure, a method for determining configuration is proposed. A second base station performs the method in a second service network, and includes: receiving user consent preference of a terminal transmitted by a second core network in a second service network, where the terminal handovers from a first base station in the first service network to a second base station in the second service network, and the user consent preference is configured to indicate whether the terminal consents to report terminal location information; and determining whether to configure the terminal to report terminal location information based on the user consent preference.

According to the fourth aspect of the embodiments of the present disclosure, a method for reporting location information is proposed. The method is performed by a terminal, and includes: receiving configuration information transmitted by a second base station, where the terminal handovers from a first base station in a first service network to the second base station in a second service network, and the second base station transmits the configuration information to the terminal in response to determining that the terminal consents to report terminal location information based on user consent preference; and reporting, based on the configuration information, the terminal location information to the second base station.

According to the fifth aspect of embodiments of the present disclosure, an apparatus for transmitting user consent preference is proposed. The apparatus includes: a processing module, configured to determine that a terminal handovers from a first base station in the first service network to a second base station in a second service network; and a transmitting module, configured to transmit user consent preference of the terminal to a second core network in the second service network; where the user consent preference is configured to indicate whether the terminal consents to report terminal location information.

According to the sixth aspect of the disclosed embodiment, an apparatus for determining user consent preference is proposed. The apparatus includes: a receiving module, configured to receive user consent preference of a terminal transmitted by a first core network in a first service network, where the terminal handovers from a first base station in the first service network to a second base station in the second service network, and the user consent preference is configured to indicate whether the terminal consents to report terminal location information; and a processing module, configured to determine, in response to determining that the user consent preference is not received from the first core network, the user consent preference through other means.

According to the seventh aspect of the disclosed embodiment, an apparatus for determining configuration is proposed. The apparatus is applied to a second base station in a second service network, and includes: a receiving module, configured to receive user consent preference of a terminal transmitted by a second core network in a second service network, where the terminal handovers from a first base station in the first service network to a second base station in the second service network, and the user consent preference is configured to indicate whether the terminal consents to report terminal location information; and a processing module, configured to determine whether to configure the terminal to report terminal location information based on the user consent preference.

According to the eighth aspect of the disclosed embodiment, an apparatus for reporting location information is proposed. The apparatus is applied to a terminal, and includes: a receiving module, configured to receive configuration information transmitted by a second base station, where the terminal handovers from a first base station in a first service network to the second base station in a second service network, and the second base station transmits the configuration information to the terminal in response to determining that the terminal consents to report terminal location information based on user consent preference; and a transmitting module, configured to report, based on the configuration information, the terminal location information to the second base station.

According to the ninth aspect of the disclosed embodiment, a communication device is proposed, including: one or more processors; and one or more memories for storing a computer programs; where when the one or more processors execute the computer program, the method for transmitting user consent preference and/or the method for determining user consent preference mentioned above is implemented.

According to the tenth aspect of the embodiments of the present disclosure, a communication device is proposed, including: one or more processors; and one or more memories for storing a computer programs; where when the one or more processors execute the computer program, the method for determining configuration described above is implemented.

According to the eleventh aspect of the embodiments of the present disclosure, a communication device is proposed, including: one or more processors; and one or more memories for storing a computer programs; where when the one or more processors execute the computer program, the method for reporting location information described above is implemented.

According to the twelfth aspect of the embodiments of the present disclosure, a computer-readable storage medium is proposed for storing a computer program is provided, where when the computer program is executed by one or more processors, the method for transmitting user consent preference and/or the method for determining user consent preference mentioned above is implemented.

According to the thirteenth aspect of the embodiments of the present disclosure, a computer-readable storage medium is proposed for storing a computer program, where when the computer program is executed by one or more processors, the method for determining configuration described above is implemented.

According to the fourteenth aspect of the embodiments of the present disclosure, a computer-readable storage medium is proposed for storing a computer program, where when the computer program is executed by one or more processors, the method for reporting location information described above is implemented.

According to the embodiments of the present disclosure, when a terminal needs to handover from the first base station to the second base station, the first core network can determine that the terminal needs to handover from the first base station to the second base station, and transmit the user consent preference of the terminal to the second core network, such that the second core network can further transmit the user consent preference to the second base station, such that the second base station can determine whether the terminal consents to report the terminal location information based on the user consent preference, and make appropriate configurations for the terminal.

### BRIEF DESCRIPTION OF DRAWINGS

In order to more clearly illustrate the technical solutions according to the embodiments of the present disclosure, drawings that need to be used in the description of the embodiments will be briefly introduced below. The drawings in the following description only relate to some embodiments of the present disclosure. For those skilled in the art, other drawings can also be obtained according to these drawings without creative effort.

FIG. 1 is a schematic flowchart of a method for transmitting user consent preference according to an embodiment of the present disclosure.

FIG. 2 is a schematic flowchart of another method for transmitting user consent preference according to an embodiment of the present disclosure.

FIG. 3 is a schematic flowchart of a method for determining user consent preference according to an embodiment of the present disclosure.

FIG. 4 is a schematic flowchart of another method for determining user consent preference according to an embodiment of the present disclosure.

FIG. 5 is a schematic flowchart of a method for determining configuration according to an embodiment of the present disclosure.

FIG. 6 is a schematic flowchart of a method for reporting location information according to an embodiment of the present disclosure.

FIG. 7 is a schematic flowchart of a second base station obtaining user consent preference according to an embodiment of the present disclosure.

FIG. 8 is a schematic block diagram of an apparatus for transmitting user consent preference according to an embodiment of the present disclosure.

FIG. 9 is a schematic block diagram of an apparatus for determining user consent preference according to an embodiment of the present disclosure.

FIG. 10 is a schematic block diagram of an apparatus for determining configuration according to an embodiment of the present disclosure.

FIG. 11 is a schematic block diagram of an apparatus for reporting location information according to an embodiment of the present disclosure.

FIG. 12 is a schematic block diagram of a device for determining configuration according to an embodiment of the present disclosure.

FIG. 13 is a schematic block diagram of a device for reporting location information according to an embodiment of the present disclosure.

### DETAILED DESCRIPTION

The technical solutions in the embodiments of the present disclosure are clearly described below with reference to the accompanying drawings in the embodiments of the present disclosure. The embodiments described are merely some embodiments of the present disclosure, and not all embodiments. Other embodiments achieved by those skilled in the art according to the embodiments in the present disclosure without paying creative work shall all fall within the scope of protection of the present disclosure.

The term used in the embodiments of the present disclosure is for the purpose of describing particular examples only and is not intended to limit the embodiments of the present disclosure. As used in embodiments of the present disclosure and the appended claims, the singular forms “a,” “an” and “the” are intended to include the plural forms as well, unless the context clearly indicates otherwise. It should further be understood that the term “and/or” as used herein refers to and includes any and all possible combinations of one or more of the associated listed items.

It shall be understood that, although the terms “first,” “second,” “third,” and the like may be used herein to describe various information, the information should not be limited by these terms. These terms are only used to distinguish the same type of information from each other. For example, without departing from the scope of the present disclosure, first information may be referred as second information; and similarly, second information may also be referred as first information. Depending on the context, the word “if” as used herein can be interpreted as “at the time of,” “when” or “in response to determining”.

For the purpose of simplicity and ease of understanding, the terms used in the present disclosure to represent comparison are “greater than,” “less than,” “higher than” or “lower than”. But for those skilled in the art, it can be understood that the term “greater than” also encompasses the meaning of “greater than or equal to,” “less than” also encompasses the meaning of “less than or equal to,” “higher than” encompasses the meaning of “higher than or equal to,” and “lower than” also encompasses the meaning of “lower than or equal to”.

All embodiments of the present disclosure are mainly applied in scenarios of a handover of a terminal from a first service network to a second service network. For example, when the terminal is at the junction of the first service network and the second service network, an access network of the first service network can determine a handover of the terminal from the first service network to the second service network. The access network of the first service network is a non-terrestrial network, and/or the access network of the second service network is a non-terrestrial network.

For example, when a terminal is in the first service network, the network device in the first service network can determine the user consent preference of the terminal in the first service network. For example, if the terminal handovers from the first base station in the first service network to the second base station in the second service network, the first base station and the first core network corresponding to the first base station can determine the user consent preference of the terminal in the first service network.

However, the network device in the second service network that the terminal needs to handover to does not know the user consent preference of the terminal. Therefore, it is necessary to enable the network device in the second service network to obtain the user consent preference of the terminal in a timely manner, such that the second base station in the second service network can accurately determine, based on the user consent preference, whether the terminal consents (or allows) to report the terminal location information, and then make appropriate configurations for the terminal.

The following embodiments provide exemplary explanations of the technical solutions of the present disclosure from the aspects of the network device (such as the second core network and the second base station) in the second service network obtaining the user consent preference, and the network device (such as the first core network) in the first service network transmitting the user consent preference to the network device in the second service network, etc.

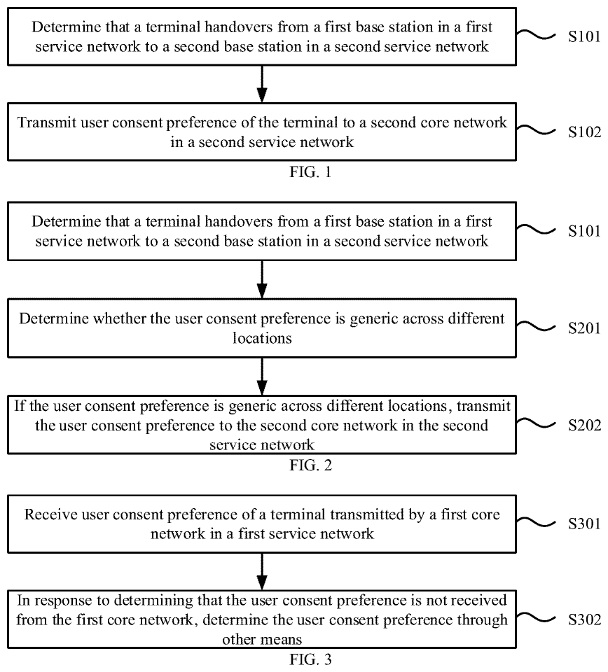

FIG. 1 is a schematic flowchart of a method for transmitting user consent preference according to an embodiment of the present disclosure. The method for transmitting user consent preference shown in this embodiment can be performed by a first core network in a first service network, specifically by an AMF (Access and Mobility Management Function) in the first core network. The first core network can communicate with the first base station in the first service network, and can also communicate with the terminal when the terminal is in the first service network. The terminal includes but is not limited to a communication device such as a mobile phone, a tablet computer, a wearable device, a sensor, or an IoT device.

As shown in FIG. 1, the method for transmitting user consent preference may include the following steps S101 to S102.

In step S101, it is determined that a terminal handovers from a first base station in a first service network to a second base station in a second service network.

In step S102, user consent preference of the terminal is transmitted to a second core network in a second service network, where the user consent preference is configured to indicate whether the terminal consents to report location information.

In an embodiment, when a terminal needs to handover from the first base station to the second base station, the first base station can first determine that the terminal needs to handover to the second base station, and then transmit a Handover Required message to the first core network, where the Handover Required message can carry the identifier of the second base station. In embodiments of the present disclosure, there is a second core network in the second service network, and the second base station can communicate with the second core network.

Furthermore, the first core network can determine that the terminal needs to handover from the first base station to the second base station, and transmit the user consent preference of the terminal to the second core network, such that the second core network can further transmit the user consent preference to the second base station, such that the second base station can determine whether the terminal consents to report the terminal location information based on the user consent preference, and make appropriate configurations for the terminal.

For example, in the case where the second base station determines, based on the user consent preference, that the user consents to report the terminal location information, the second base station can transmit configuration information to the terminal, and the terminal can report the terminal location information to the second base station based on the configuration information. In the case where the second base station determines, based on the user consent preference, that the terminal does not consent to report the terminal location information, the second base station does not transmit configuration information to the terminal, and the terminal does not report the terminal location information to the second base station, which is conducive to avoiding the leakage of the terminal location information.

It should be noted that the base station in all embodiments of the present disclosure may refer to a base station in a non-terrestrial network, which may be referred to as a non-terrestrial network-radio access network (NTN-RAN). In the scenario where the terminal needs to handover from the first base station to the second base station, the first base station can be referred to as a source NTN-RAN, and the second base station can be referred to as a target NTN-RAN. Similarly, the first core network can be referred to as a source AMF, and the second core network can be referred to as a target AMF.

In an embodiment, the method further includes: receiving the identifier of the second base station transmitted by the first base station; and transmitting the identifier of the second base station to the second core network.

When the first base station determines that the terminal needs to handover to the second base station, the first base station can determine the identifier (which can be referred to as the Target NTN-RAN ID) of the second base station, and transmitting the identifier of the second base station to the first core network. Then, the first core network can transmit the identifier of the second base station to the second core network, such that the second core network can obtain user consent preference associated with the second base station based on the identifier of the second base station. The steps for the second core network obtaining the user consent preference will be explained in detail in the subsequent embodiments.

FIG. 2 is a schematic flowchart of another method for transmitting user consent preference according to an embodiment of the present disclosure. As shown in FIG. 2, the method further includes the following steps S201 and S202.

In step S201, it is determined whether the user consent preference is generic across different locations.

Where transmitting the user consent preference of the terminal to the second core network in the second service network includes:

In step S202, if the user consent preference is generic across different locations, the user consent preference is transmitted to the second core network in the second service network.

In an embodiment, due to the large coverage range of the satellite in a non-terrestrial network, the first service network where the terminal is currently located and the second service network that the terminal needs to handover to can belong to coverage regions of different satellites, or belong to the coverage region of the same satellite but belong to different operator networks. In any case, the central distance between the first service network and the second service network will be far apart, and there may even be situations where the first service network and the second service network belong to different regions or countries.

The user consent preference of the terminal can be generic across different locations, or non generic across different locations, i.e., specific in different locations, such as associated with AMF (e.g. specific to AMF, i.e. different user consent preference corresponds to different AMFs), or associated with base stations (e.g. specific to base stations, i.e., different user consent preference corresponds to different base stations); or the locations in the present disclosure can also be based on coverage regions of different satellites, coverage regions of different operator networks, or other area division manners that can reflect different locations, which is not limited in the present disclosure.

In the case where the user consent preference of the terminal is generic across different locations, the user consent preference of the terminal in the first service network and the user consent preference of the terminal in the second service network can be the same. Therefore, the user consent preference stored in the first core network is also applicable to the second core network. Therefore, the first core network can transmit the user consent preference stored in the first core network to the second core network.

In the case where the user consent preference of the terminal is not generic across different locations, the user consent preference of the terminal in the first service network and the user consent preference of the terminal in the second service network may be different. Therefore, the user consent preference stored in the first core network may not be applicable to the second core network, so the first core network does not need to transmit the user consent preference stored in the first core network to the second core network. In this case, the second core network can determine the user consent preference of the terminal through other means, which will be explained in the subsequent embodiments.

FIG. 3 is a schematic flowchart of a method for determining user consent preference according to an embodiment of the present disclosure. The method for transmitting user consent preference shown in this embodiment can be performed by a second core network in a second service network, specifically by an AMF in the second core network. The second core network can communicate with the second base station in the second service network, and can also communicate with the terminal when the terminal is in the second service network. The terminal includes but is not limited to a communication device such as a mobile phone, a tablet computer, a wearable device, a sensor, or an IoT device.

As shown in FIG. 3, the method for determining user consent preference may include the following steps S301 and S302.

In step S301, user consent preference of a terminal transmitted by a first core network in a first service network is received, where the terminal handovers from a first base station in the first service network to a second base station in the second service network, and the user consent preference is configured to indicate whether the terminal consents to report terminal location information; and

In step 302, in response to determining that the user consent preference is not received from the first core network, the user consent preference is determined through other means.

In an embodiment, when a terminal needs to handover from the first base station to the second base station, the first base station can first determine that the terminal needs to handover to the second base station, and then transmit a Handover Required message to the first core network, where the Handover Required message can carry the identifier of the second base station.

Furthermore, the first core network can determine that the terminal needs to handover from the first base station to the second base station and transmit the user consent preference of the terminal to the second core network. In the case where the second core network does not receive the user consent preference of the terminal from the first base station (for example, because the user consent preference of the terminal is not generic across different locations), the user consent preference of the terminal can be determined through other means to ensure that the user consent preference of the terminal can be transmitted to the second base station. The second core network can subsequently transmit the user consent preference to the second base station, such that the second base station can determine whether the terminal consents to report the terminal location information based on the user consent preference, and make appropriate configurations for the terminal.

For example, in the case where the second base station determines, based on the user consent information, that the user consents to report the terminal location information, the second base station can transmit configuration information to the terminal, and the terminal can report the terminal location information to the second base station based on the configuration information. In the case where the second base station determines, based on the user consent preference, that the terminal does not consent to report the terminal location information, the second base station does not transmit configuration information to the terminal, and the terminal does not report the terminal location information to the second base station, which is conducive to avoiding the leakage of the terminal location information.

In an embodiment, obtaining the user consent preference through other means includes: determining whether the user consent preference has been stored, and determining the user consent preference in response to determining that the user consent preference has been stored.

In the case where the first core network has not transmitted the user consent preference to the second core network, the second core network can determine whether the second core network has stored the user consent preference. If the second core network has stored the user consent preference, the stored user consent preference can be transmitted to the second base station.

For example, the second core network can determine whether the context of the terminal has been stored, and further obtain the user consent preference in the context of the terminal when the context of the terminal has been stored. The user consent preference in the context can include user consent preference that is generic across different locations, or user consent preference that is not generic across different locations, such as being associated with AMF (e.g., specific to AMF, i.e., different AMF correspond to different user consent preference), or associated with base stations (e.g., specific to base stations, i.e., different base stations correspond to different user consent preference), where user consent preference that is not generic across different locations can be queried based on the identifier of the second base station.

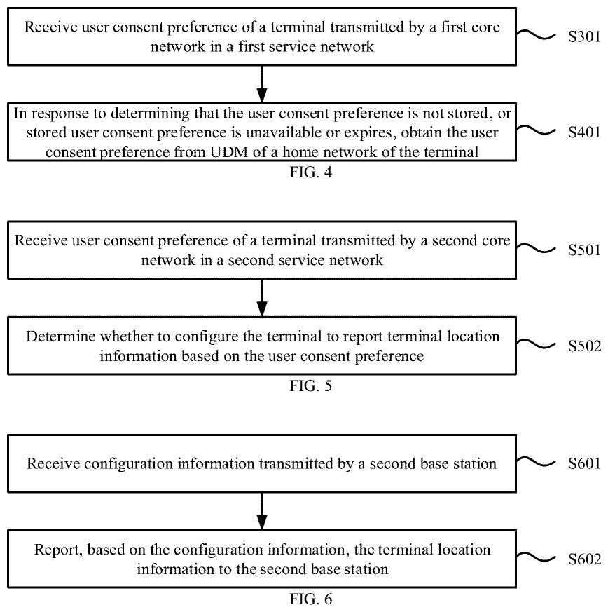

FIG. 4 is a schematic flowchart of another method for determining user consent preference according to an embodiment of the present disclosure. As shown in FIG. 4, obtaining user consent preference through other means also includes step S401.

In step S401, in response to determining that the user consent preference is not stored, or stored user consent preference is unavailable or expires, the user consent preference is obtained from a unified data management function (UDM) of a home network of the terminal.

When the second core network does not store the user consent preference of the terminal, or although the user consent preference of the terminal is stored, the stored user consent preference is unavailable or expires, the second core network can obtain the user consent preference of the terminal from the UDM of the home network of the terminal.

Since the Unified Data Repository (UDR) corresponding to the UDM of the home network of the terminal stores the subscription information of the terminal, where the subscription information includes the user consent preference of the terminal, the second core network can obtain the user consent preference of the terminal from the UDM.

In an embodiment, obtaining the user consent preference from the unified data management function (UDM) of the home network of the terminal includes: transmitting an obtaining request to the UDM, where the obtaining request is configured to request the UDM to transmit the user consent preference to the second core network; and receiving the user consent preference transmitted by the UDM.

For example, the second core network can determine the home network of the terminal and then transmit an obtaining request to the UDM of the home network of the user to request the UDM to transmit the user consent preference of the terminal to the second core network. The obtaining request can be Nudm_SDM_Get request.

After receiving the obtaining request, UDM can determine the subscription data of the terminal in UDR based on the Subscription Permanent Identifier (SUPI) of the terminal, and then obtain the user consent preference of the terminal from the subscription data, and transmit it to the second core network. For example, UDM can carry the user consent preference of the terminal in the response to the obtaining request and transmit a message to the second core network, where the response message includes but is not limited to Nudm_SDM_Get response.

In an embodiment, the method further includes: storing the obtained user consent preference; or updating stored user consent preference according to obtained user consent preference.

When the second core network does not store the user consent preference of the terminal, the second core network can store the obtained user consent preference after receiving the user consent preference from the UDM; and when the user consent preference of the terminal is stored, but the stored user consent preference is unavailable or expires, after receiving the user consent preference of the terminal from UDM, the second core network can update the stored user consent preference based on the obtained user consent preference.

In an embodiment, the method further includes: receiving an identifier of the second base station transmitted by the first core network.

The second core network can receive the identifier of the second base station from the first core network. According to the identifier of the second base station, on the one hand, the second core network can determine to transmit the user consent preference of the terminal to the second base station. On the other hand, the second core network or UDM can determine the user consent preference generic across different locations based on the identifier of the second base station.

For example, UDM can transmit the user consent preference obtained from UDR to the second core network. The second core network determines whether the user consent preference is generic or not across different locations. If the user consent preference is not generic across different locations, the user consent preference corresponding to the second base station can be determined based on the identifier of the second base station and transmitted to the second base station. If the user consent preference transmitted by UDM is generic across different locations, the second core network does not need to determine the user consent preference corresponding to the second base station based on the identifier of the second base station. Of course, the user consent preference can also be specific to AMF, and the second core network can transmit the user consent preference corresponding to the second AMF to the second base station.

For example, the second core network can transmit the identifier of the second base station to the UDM. The UDM determines the user consent preference corresponding to the second base station in the UDR based on the identifier of the second base station, and then transmits the user consent preference corresponding to the second base station to the second core network, and the second core network transmits the user consent preference to the second base station. Of course, the user consent preference can also be specific to the AMF. The second core network can transmit the identifier of the second AMF to the UDM. The UDM determines the user consent preference corresponding to the second AMF in the UDR based on the identifier of the second AMF, and then transmits the user consent preference corresponding to the second AMF to the second core network, and the second core network transmits the user consent preference to the second base station.

In an embodiment, the method further includes: determining that the user consent preference indicates that the terminal consents to report the terminal location information, and transmitting the user consent preference to the second base station.

In an embodiment, transmitting the user consent preference to the second base station includes transmitting a handover request to the second base station, where the handover request carries the user consent preference.

In an embodiment, the method further includes: determining that the user consent preference indicates that the terminal does not consent to report the terminal location information, not transmitting the user consent preference to the second base station, or transmitting the user consent preference to the second base station, where the user consent preference indicates that the terminal does not consent to report the terminal location information.

In an embodiment, after determining the user consent preference of the terminal, the second core network can analyse the user consent preference to determine whether the terminal consents to report the terminal location information.

In the case where it is determined that the terminal consents to report the terminal location information, the second core network may transmit the user consent preference of the terminal to the second base station. For example, the user consent preference may be carried in a handover request message and transmitted to the second base station.

In the case where it is determined that the terminal does not consent to report the terminal location information, the second core network may not transmit the user consent preference of the terminal to the second base station. Therefore, when the second base station does not receive the user consent preference of the terminal, it can assume that the terminal does not consent to report the terminal location information, and the terminal will not be configured to report the terminal location information. Alternatively, the second core network can transmit the user consent preference to the second base station, and since the user consent preference indicates that the terminal does not consent to report the terminal location information, the second base station can also determine that the terminal does not consent to report the terminal location information and will not configure the terminal to report the terminal location information.

FIG. 5 is a schematic flowchart of a method for determining configuration according to an embodiment of the present disclosure. The method for determining configuration in this embodiment can be performed by the second base station in the second service network. The second base station can communicate with the second core network in the second service network, and can also communicate with the terminal when the terminal is in the second service network. The terminal includes but is not limited to a communication device such as a mobile phone, a tablet computer, a wearable device, a sensor, or an IoT device.

As shown in FIG. 5, the configuration determining method may include the following steps S501 and S502.

In step S501, user consent preference of a terminal transmitted by a second core network in a second service network is received, where the terminal handovers from the a first base station in the first service network to a second base station in the second service network, and the user consent preference is configured to indicate whether the terminal consents to report terminal location information.

In step S502, it is determined whether to configure the terminal to report terminal location information based on the user consent preference.

In an embodiment, when a terminal needs to handover from the first base station to the second base station, the first base station can first determine that the terminal needs to handover to the second base station, and then transmit a Handover Required message to the first core network, where the Handover Required message can carry the identifier of the second base station.

Furthermore, the first core network can determine that the terminal needs to handover from the first base station to the second base station and transmit the user consent preference of the terminal to the second core network. In the case where the second core network does not receive the user consent preference of the terminal from the first core network (for example, because the user consent preference of the terminal is not generic across different locations), the user consent preference of the terminal can be determined through other means to ensure that the user consent preference of the terminal can be transmitted to the second base station. The second core network can further transmit the user consent preference to the second base station, and the second base station will determine whether to configure the terminal to report terminal location information based on the user consent preference, to make appropriate configurations for the terminal.

In an embodiment, receiving the user consent preference of the terminal transmitted by the second core network in the second service network includes receiving a handover request transmitted by the second core network, where the handover request carries the user consent preference. That is, the second core network can carry the user consent preference in the handover request and transmit it to the second base station.

In an embodiment, determining whether to configure the terminal to report terminal location information based on the user consent preference includes: in response to determining that the user consent preference indicates that the terminal consents to report the terminal location information, configuring the terminal to report the terminal location information; in response to determining that the user consent preference indicates that the terminal does not consent to report the terminal location information, not configuring the terminal to report the terminal location information.

In the case where the second base station determines, based on the user consent information, that the user consents to report the terminal location information, the second base station can transmit configuration information to the terminal, and the terminal can report the terminal location information to the second base station based on the configuration information. In the case where the second base station determines, based on the user consent preference, that the terminal does not consent to report the terminal location information, the second base station does not transmit configuration information to the terminal, and the terminal does not report the terminal location information to the second base station, which is conducive to avoiding the leakage of the terminal location information.

In an embodiment, configuring the terminal to report terminal location information includes transmitting a radio resource control reconfiguration (RRCReconfiguration) message to the terminal, where the RRCReconfiguration message carries a configuration for reporting the terminal location information. That is, the second base station can transmit configuration information (including but not limited to time domain resources, frequency domain resources, etc.)

to the terminal through RRCReconfiguration message when the second base station determines that the terminal consents to report the terminal location information.

FIG. 6 is a schematic flowchart of a method for reporting location information according to an embodiment of the present disclosure. The method for reporting location information in this embodiment can be performed by the terminal that can communicate with the network device such as a base station or a core network. The terminal includes but is not limited to a communication device such as a mobile phone, a tablet, a wearable device, a sensor, or an Internet of Things (IoT) device.

As shown in FIG. 6, the method for reporting location information may include step S601 and S602.

In step S601, configuration information transmitted by a second base station is received, where the terminal handovers from a first base station in a first service network to the second base station in a second service network, and the second base station transmits the configuration information to the terminal in response to determining that the terminal consents to report terminal location information based on user consent preference.

In step S602, based on the configuration information, the terminal location information is reported to the second base station.

In an embodiment, when a terminal needs to handover from the first base station to the second base station, the first base station can first determine that the terminal needs to handover to the second base station, and then transmit a Handover Required message to the first core network, where the Handover Required message can carry the identifier of the second base station.

Furthermore, the first core network can determine that the terminal needs to handover from the first base station to the second base station and transmit the user consent preference of the terminal to the second core network. In the case where the second core network does not receive the user consent preference of the terminal from the first core network (for example, because the user consent preference of the terminal is not generic across different locations), the user consent preference of the terminal can be determined through other means to ensure that the user consent preference of the terminal can be transmitted to the second base station. The second core network can further transmit the user consent preference to the second base station, and the second base station will determine whether to configure the terminal to report terminal location information based on the user consent preference, to make appropriate configurations for the terminal.

For example, in the case where the second base station determines, based on the user consent information, that the user consents to report the terminal location information, the second base station can transmit configuration information to the terminal, and the terminal can report the terminal location information to the second base station based on the configuration information. In the case where the second base station determines, based on the user consent preference, that the terminal does not consent to report the terminal location information, the second base station does not transmit configuration information to the terminal, and the terminal does not report the terminal location information to the second base station, which is conducive to avoiding the leakage of the terminal location information.

The above embodiments describe the process of the second base station obtaining user consent preference of the terminal, and determining whether to configure the terminal to report terminal location information based on the user consent preference, from the perspectives of the first core network, the second core network, the second base station, and the terminal. The following provides an exemplary description of this process from the perspective of multi-party interaction.

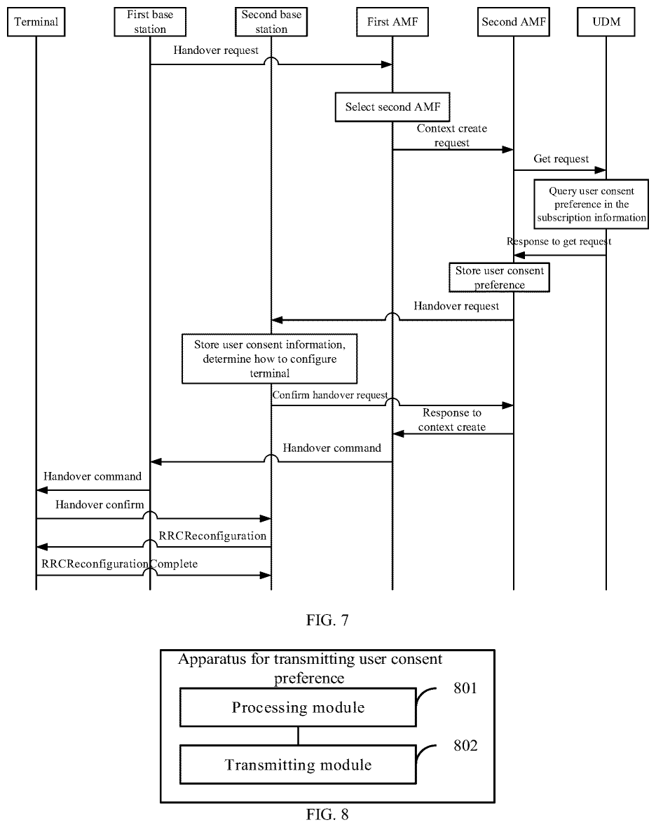

FIG. 7 is a schematic flowchart of a second base station obtaining user consent preference according to an embodiment of the present disclosure. As shown in FIG. 7,

when the terminal performs communications in a non-terrestrial network and moves to the junction of the first service network and the second service network, the first base station can determine that the terminal needs to handover from the first service network to the second base station in the second service network, and then the first base station determines to trigger relocation through the N2 interface.

The first base station can transmit a handover request message to the first core network (such as the first AMF in the first core network) in the first service network. The handover request message can carry the identifier of the first base station, and a Source to Target transparent container, etc.

After receiving the handover request message, the first core network can determine the second service network that the terminal needs to handover to, and select the second core network (such as the second AMF in the second core network) in the second service network, and determine whether the user consent preference of the terminal is generic or not across different locations.

Then, the first core network can transmit a user equipment context create request (such as Namf_Communication_CreateUEContext Request) to the second core network, where the user equipment context create request can carry the identifier of the second base station. When the first core network determines that the user consent preference of the terminal is generic across different locations, the user consent preference of the terminal can be carried in the user equipment context create request and be transmitted to the second core network, When the first core network determines that the user consent preference of the terminal is not generic across different locations (e.g., the user consent preference of the terminal is associated with the first AMF and/or the first base station, i.e., specific to the first AMF and/or the first base station), then the user equipment context create request does not carry the user consent preference of the terminal.

If the second core network does not receive the user consent preference of the terminal from the first core network, the second core network will first determine whether the second core network itself has stored the user consent preference of the terminal (which can be generic user consent preference across different locations, or user consent preference associated with the second AMF and/or the second base station). If the second core network does not store the user consent preference of the terminal, or if the second core network has stored the user consent preference of the terminal, but the user consent preference of the terminal is unavailable or expires, the second core network can obtain the user consent preference of the terminal from the UDM of the home network of the terminal. For example, the second core network can transmit a Nudm SDM Get request to the UDM to request the user consent preference of the terminal, where the Nudm_SDM_Get request can carry the identifier of the second base station.

After receiving the Nudm_SDMG-Get request, the UDM can query the user consent preference of the terminal in the user subscription data of UDR based on SUPI. It can also further query the user consent preference (i.e., the user consent preference of the terminal specific to the second AMF and/or the second base station) of the terminal associated with the second AMF and/or the second base station based on the identifier of the second base station.

Subsequently, the UDM transmits a response to the obtaining request to the second core network, such as the Nudm_SDM_Get response, where the Nudm_SDM_Get response can carry the user consent preference of the terminal.

After receiving the user consent preference of the terminal from the first core network or the UDM, the second core network can store the user consent preference of the terminal or update the stored user consent preference. Furthermore, the second core network can determine whether the terminal consents to report the terminal location information based on the user consent preference of the terminal. When the second core network determines that the terminal consents to report the terminal location information, the second core network can transmit the user consent preference of the terminal to the second base station. When the second core network determines that the terminal does not consent to report the terminal location information, the second core network cannot transmit the user consent preference of the terminal to the second base station, or can transmit the user consent preference of the terminal to the second base station to inform the base station through the user consent preference of the terminal that the terminal does not consent to report the terminal location information.

The second core network can transmit a Handover Request message to the second base station, where the Handover Request message can carry the user consent preference of the terminal.

After receiving the user consent preference of the terminal, the second base station can store the user consent preference of the terminal in the context for the terminal, and determine whether to configure the terminal to report terminal location information based on the user consent preference of the terminal.

In addition, the second base station can further return a Handover Request Acknowledge message to the second core network, such that the second core network can return a User Equipment Context Create Response (such as Namf_Communication_CreateUEContext Response) to the first core network. The first core network then transmits a Handover Command to the first base station, and the first base station then transmits the Handover Command to the terminal. After the terminal completes synchronization in the cell corresponding to the first base station and the cell corresponding to the second base station, the terminal can transmit a Handover Confirm message to the second base station.

In the case where the second base station determines, based on the user consent information, that the user consents to report the terminal location information, the second base station can transmit configuration information to the terminal, and the terminal can report the terminal location information to the second base station based on the configuration information. In the case where the second base station determines, based on the user consent preference, that the terminal does not consent to report the terminal location information, the second base station does not transmit configuration information to the terminal, and the terminal does not report the terminal location information to the second base station. The configuration information can be carried in the RRCReconfiguration message. For example, the configuration information can be specifically carried in the includeCommonLocationInfo of the reportConfig.

The terminal can return an RRCReconfigurationcomplete message to the second base station and report the location information of the terminal to the second base station based on the configuration information transmitted by the second base station.

Corresponding to the embodiments of the method for transmitting user consent preference, the method for determining user consent preference, the method for determining configuration, and the method for reporting location information mentioned above, the present disclosure further provides embodiments of an apparatus for transmitting user consent preference, an apparatus for determining user consent preference, an apparatus for determining configuration, and an apparatus for reporting location information.

FIG. 8 is a schematic block diagram of an apparatus for transmitting user consent preference according to an embodiment of the present disclosure. The apparatus for transmitting user consent preference in this embodiment is the first core network (such as AMF in the first core network) in the first service network, or a device composed of modules of the first core network. The first core network can communicate with the first base station in the first service network, and can also communicate with the terminal when the terminal is in the first service network. The terminal includes but is not limited to a communication device such as a mobile phone, a tablet computer, a wearable device, a sensor, or an IoT (Internet of Things) device.

As shown in FIG. 8, the apparatus for transmitting user consent preference may include:
a processing module 801, configured to determine that a terminal handovers from a first base station in the first service network to a second base station in a second service network; and
a transmitting module 802, configured to transmit user consent preference of the terminal to a second core network in the second service network;
where the user consent preference is configured to indicate whether the terminal consents to report terminal location information.

In an embodiment, the processing module is further configured to determine whether the user consent preference is generic across different locations; where the transmitting module is configured to transmit, in response to determining that the user consent preference is generic across different locations, the user consent preference to the second core network in the second service network.

In an embodiment, the apparatus further includes a receiving module configured to receive the identifier of the second base station transmitted by the first base station; and the transmitting module is further configured to transmit the identifier of the second base station to the second core network.

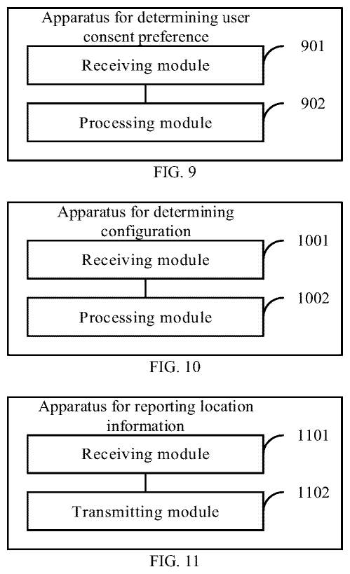

FIG. 9 is a schematic block diagram of an apparatus for determining user consent preference according to an embodiment of the present disclosure. The apparatus for transmitting user consent preference in this embodiment can be the second core network (such as AMF in the second core network) in the second service network, or a device composed of modules of the second core network. The second core network can communicate with the second base station in the second service network, and can also communicate with the terminal when the terminal is in the second service network. The terminal includes but is not limited to a communication device such as a mobile phone, a tablet computer, a wearable device, a sensor, or an IoT (Internet of Things) device.

As shown in FIG. 9, the apparatus for determining user consent preference may include:
a receiving module 901, configured to receive user consent preference of a terminal transmitted by a first core network in a first service network, where the terminal handovers from a first base station in the first service network to a second base station in the second service network, and the user consent preference is configured to indicate whether the terminal consents to report terminal location information; and
a processing module 902, configured to determine, in response to determining that the user consent preference is not received from the first core network, the user consent preference through other means.

In an embodiment, the processing module is configured to determine whether the user consent preference has been stored, and determine the user consent preference in response to determining that the user consent preference has been stored.

In an embodiment, the processing module is configured to obtain, in response to determining that the user consent preference is not stored, or stored user consent preference is unavailable or expires, the user consent preference from a unified data management function (UDM) of a home network of the terminal.

In an embodiment, the processing module is further configured to store the obtained user consent preference; or update stored user consent preference according to obtained user consent preference.

In an embodiment, the processing module is configured to transmit an obtaining request to the UDM, where the obtaining request is configured to request the UDM to transmit the user consent preference to the second core network; and receiving the user consent preference transmitted by the UDM.

In an embodiment, the receiving module is further configured to receive an identifier of the second base station transmitted by the first core network.

In an embodiment, the apparatus further includes a transmitting module configured to determine that the user consent preference indicates that the terminal consents to report the terminal location information, and transmit the user consent preference to the second base station.

In an embodiment, the transmitting module is configured to transmit a handover request to the second base station, where the handover request carries the user consent preference.

In an embodiment, the apparatus further includes a transmitting module configured to determine that the user consent preference indicates that the terminal does not consent to report the terminal location information, not transmitting the user consent preference to the second base station, or transmitting the user consent preference to the second base station, where the user consent preference indicates that the terminal does not consent to report the terminal location information.

FIG. 10 is a schematic block diagram of an apparatus for determining configuration according to an embodiment of the present disclosure. The apparatus for determining configuration in this embodiment can be a second base station in the second service network, or a device composed of modules of the second base station. The second base station can communicate with the second core network in the second service network, and can also communicate with the terminal when the terminal is in the second service network. The terminal includes but is not limited to a communication device such as a mobile phone, a tablet computer, a wearable device, a sensor, or an IoT device.

As shown in FIG. 10, the apparatus for determining configuration may include:
a receiving module 1001, configured to receive user consent preference of a terminal transmitted by a second core network in a second service network, where the terminal handovers from a first base station in the first service network to a second base station in the second service network, and the user consent preference is configured to indicate whether the terminal consents to report terminal location information; and
a processing module 1002, configured to determine whether to configure the terminal to report terminal location information based on the user consent preference.

In an embodiment, the processing module is configured to: configure the terminal to report the terminal location information, in response to determining that the user consent preference indicates that the terminal consents to report the terminal location information; not configure the terminal to report the terminal location information, in response to determining that the user consent preference indicates that the terminal does not consent to report the terminal location information.

In an embodiment, the processing module is configured to transmit a radio resource control reconfiguration (RRCReconfiguration) message to the terminal, where the RRCReconfiguration message carries a configuration for reporting the terminal location information.

In an embodiment, the receiving module is configured to receive a handover request transmitted by the second core network, where the handover request carries the user consent preference.

FIG. 11 is a schematic block diagram of an apparatus for reporting location information according to an embodiment of the present disclosure. The apparatus for determining configuration in this embodiment can be a terminal or an apparatus composed of modules of the terminal, where the terminal can communicate with the network device such as the base station and the core network. The terminal includes but is not limited to a communication device such as a mobile phone, a tablet, a wearable device, a sensor, or an Internet of Things (IoT) device.

As shown in FIG. 11, the apparatus for reporting location information may include:
a receiving module 1101, configured to receive configuration information transmitted by a second base station, where the terminal handovers from a first base station in a first service network to the second base station in a second service network, and the second base station transmits the configuration information to the terminal in response to determining that the terminal consents to report terminal location information based on user consent preference; and
a transmitting module 1102, configured to report, based on the configuration information, the terminal location information to the second base station.

With regard to the device in the above examples, the specific manner in which the respective modules perform the operations has been described in detail in the examples of the related methods, and will not be explained in detail herein.

Since the device embodiments basically corresponds to the method embodiments, the relevant parts can refer to the partial description of the method embodiments. The device examples described above are merely illustrative, where the modules described as separate members may be or not be physically separated, and the members displayed as modules may be or not be physical units, i.e., may be located in one place, or may be distributed in a plurality of network modules. Part or all of the modules may be selected according to actual requirements to implement the objectives of the solutions in the examples. A person skilled in the art can understand and implement without creative work.

The embodiments of the present disclosure further provide a communication device, including: one or more processors; and one or more memories for storing a computer programs; where when the computer program is executed by the one or more processors, the method for transmitting user consent preference and/or the method for determining user consent preference according to any one of embodiments mentioned above is implemented.

The embodiments of the present disclosure further provide a communication device, including: one or more processors; and one or more memories for storing a computer programs; where when the computer program is executed by the one or more processors, the method for determining configuration according to any one of embodiments mentioned above is implemented.

The embodiments of the present disclosure further provide a communication device, including: one or more processors; and one or more memories for storing a computer programs; where when the computer program is executed by the one or more processors, the method for reporting location information according to any one of embodiments mentioned above is implemented.

The embodiments of the present disclosure further provide a computer-readable storage medium for storing a computer program is provided, where when the computer program is executed by one or more processors, the method for transmitting user consent preference and/or the method for determining user consent preference according to any one of embodiments mentioned above is implemented.

The embodiments of the present disclosure further provide a computer-readable storage medium for storing a computer program is provided, where when the computer program is executed by one or more processors, the method for determining configuration according to any one of embodiments mentioned above is implemented.

The embodiments of the present disclosure further provide a computer-readable storage medium for storing a computer program is provided, where when the computer program is executed by one or more processors, the method for reporting location information according to any one of embodiments mentioned above is implemented.

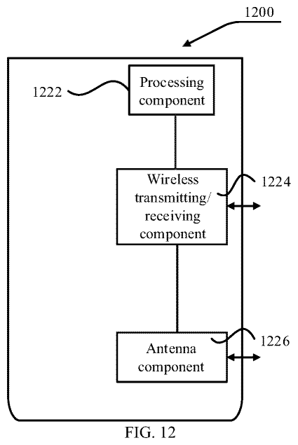

As shown in FIG. 12, FIG. 12 is a schematic block diagram of a device 1200 for determining configuration according to an embodiment of the present disclosure. The device 1200 may be provided as a base station. Referring to FIG. 12, the device 1200 includes a processing component 1222, a wireless transmitting/receiving component 1224, an antenna component 1226, and a signaling processing portion specific to a wireless interface. The processing component 1222 may further include one or more processors. One of the processors in processing component 1222 can be configured to implement the method for determining configuration described in any one of the above embodiments.

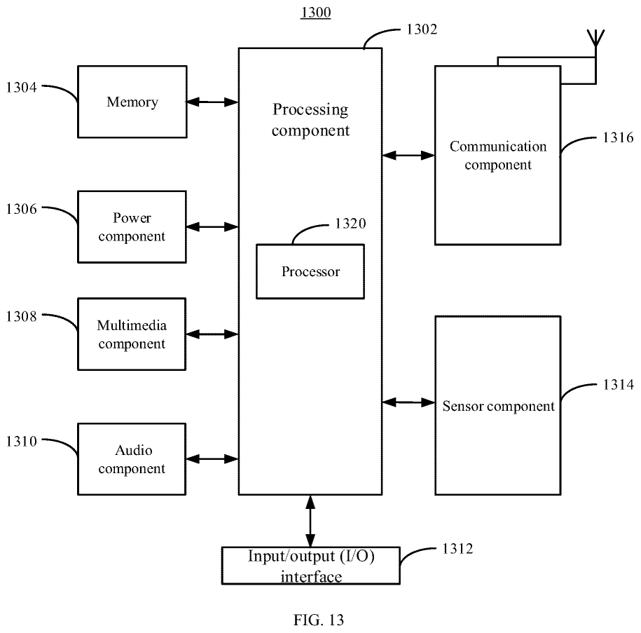

FIG. 13 is a schematic block diagram of a device 1300 for reporting location information according to an embodiment of the present disclosure. For example, device 1300 can be a mobile phone, a computer, a digital broadcast terminal, a message transmitting and receiving device, a gaming console, a tablet device, a medical device, a fitness device, a personal digital assistant, and the like.

Referring to FIG. 13, device 1300 can include one or more of the following components: processing component 1302, memory 1304, power supply component 1306, multimedia component 1308, audio component 1310, input/output (I/O) interface 1312, sensor component 1314, or a communication component 1316.

The processing component 1302 generally controls the overall operations of the device 1300, such as operations associated with display, calling, data communication, camera operation and recording operation. The processing component 1302 may include one or more processors 1320 to execute instructions to complete all or a part of the steps of the above method for reporting location information. Further, the processing component 1302 may include one or more modules to facilitate interaction between the processing component 1302 and another component. For example, the processing component 1302 may include a multimedia module to facilitate the interaction between the multimedia component 1308 and the processing component 1302.

The memory 1304 is configured to store different types of data to support the operations of the device 1300. Examples of such data include instructions of any application program or method operable on the device 1300, contact data, telephone directory data, messages, pictures, videos, and the like. The memory 1304 may be implemented by any type of volatile or non-volatile storage devices or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a disk or a CD.

The power supply component 1306 provides power for different components of the device 1300. The power supply component 1306 may include a power management system, one or more power sources, and other components associated with generating, managing and distributing power for the device 1300.

The multimedia component 1308 may include a screen for providing an output interface between the device 1300 and a user. In some examples, the screen may include a Liquid Crystal Display (LCD) and a Touch Panel (TP). If the screen includes a touch panel, the screen may be implemented as a touch screen for receiving an input signaling from a user. The touch panel may include one or more touch sensors for sensing a touch, a slide and a gesture on the touch panel. The touch sensor may not only sense a boundary of a touching or sliding movement, but also detect duration and pressure related to the touching or sliding operation. In some examples, the multimedia component 1308 may include a front camera and/or a rear camera. When the device 1300 is in an operation mode, such as a shooting mode or a video mode, the front camera and/or the rear camera can receive external multimedia data. Each of the front camera and the rear camera may be a fixed optical lens system or be of a focal length and a capability of an optical zoom.

The audio component 1310 is configured to output and/or input an audio signaling. For example, the audio component 1310 may include a microphone (MIC). When the device 1300 is in an operating mode, such as a call mode, a recording mode and a speech recognition mode, the microphone is configured to receive an external audio signal. The received audio signaling may be further stored in the memory 1304 or transmitted via the communication component 1316. In some examples, the audio component 1310 also includes a loudspeaker for outputting an audio signaling.

The I/O interface 1312 provides an interface between the processing component 1302 and a peripheral interface module which may be a keyboard, a click wheel, a button, or the like. These buttons may include but not limited to, a home button, a volume button, a start button and a lock button.

The sensor component 1314 may include one or more sensors for providing state assessments in different aspects for the device 1300. For example, sensor component 1314 can detect an open/closed state of device 1300, a relative positioning of components, such as the display and keypad of device 1300, and sensor component 1314 can also detect a change in position of device 1300 or a component of device 1300, the existence or absence of user contact with device 1300, orientation or acceleration/deceleration of device 1300, and temperature change of device 1300. The sensor component 1314 may include a proximity sensor for detecting the existence of a nearby object without any physical touch. The sensor component 1314 may also include an optical sensor, such as a CMOS or CCD image sensor used in an imaging application. In some examples, the sensor component 1314 may also include an acceleration sensor, a gyro sensor, a magnetic sensor, a pressure sensor, or a temperature sensor.

The communication component 1316 is configured to facilitate wired or wireless communication between the device 1300 and other devices. The device 1300 may access a wireless network according to a communication standard, such as WiFi, 2G, 3G, 4G LTE, 5G NR, or a combination thereof. In some embodiments, the communication component 1316 may receive a broadcast signaling or broadcast-related information from an external broadcast management system via a broadcast channel. In an example, the communication component 1316 may also include a Near Field Communication (NFC) module to facilitate short-range communications. For example, the NFC module may be implemented according to a Radio Frequency Identification (RFID) technology, an Infrared Data Association (IrDA) technology, an Ultra Wideband (UWB) technology, a Bluetooth® (BT) technology and other technologies.

In an example, the device 1300 may be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, microcontrollers, microprocessors, or other electronic components for performing the method described above.

In an example, a non-transitory computer readable storage medium including instructions, such as the memory 1304 including instructions, is also provided. The above instructions may be executed by the processor 1320 of the device 1300 to complete the above method for reporting location information. For example, the non-transitory computer-readable storage medium may be a ROM, a RAM, a CD-ROM, a magnetic tape, a floppy disc, an optical data storage device, and the like.

After considering and practicing the disclosure of the specification, other embodiments of the present disclosure will be readily apparent to those skilled in the art. The present disclosure is intended to cover any modification, use or adaptation of the present disclosure. These modifications, uses or adaptations follow the general principles of the present disclosure and include common knowledge and conventional technical means in the technical field that are not disclosed in the present disclosure. The specification and embodiments herein are intended to be illustrative only and the real scope and spirit of the present disclosure are indicated by the following claims of the present disclosure.

It is to be understood that the present disclosure is not limited to the precise structures described above and shown in the accompanying drawings and may be modified or changed without departing from the scope of the present disclosure. The scope of protection of the present disclosure is limited only by the appended claims.

It is to be noted that the relational terms such as “first” and “second” used herein are merely intended to distinguish one entity or operation from another entity or operation rather than to require or imply any such actual relation or order existing between these entities or operations. The term “including,” “containing” or any variation thereof is intended to encompass non-exclusive inclusion, such that a process, method, article or device including a series of elements includes not only those elements but also other elements not listed explicitly or those elements inherent to such a process, method, article or device. Without further limitation, the element defined by the statement “including a . . . ” do not preclude the existence of additional identical elements in the process, method, article, or device that include the element.

The above provides a detailed introduction to the methods and apparatuses provided in the embodiments of the present disclosure. Specific examples are applied in the present disclosure to explain the principles and embodiments of the present disclosure. The explanations of the above embodiments are only used to help understand the methods and core ideas of the present disclosure. Meanwhile, for those skilled in the art, based on the idea of the present disclosure, there will be changes in the embodiments and application scopes. In summary, the content of the specification should not be construed as limiting the present disclosure.

1. A method performed by a first core network in a first service network, the method comprising:
determining to handover a terminal from a first base station in the first service network to a second base station in a second service network; and
transmitting the user consent preference of the terminal to a second core network in the second service network;
wherein the user consent preference indicates whether the terminal consents to report terminal location information.

2. The method according to claim 1, further comprising:
determining whether the user consent preference is generic across different locations;
wherein transmitting the user consent preference of the terminal to the second core network in the second service network comprises:
transmitting, in response to determining that the user consent preference is generic across different locations, the user consent preference to the second core network in the second service network.

3. The method according to claim 1, further comprising:
receiving an identifier of the second base station transmitted by the first base station; and
transmitting the identifier of the second base station to the second core network.

4. A method performed by a second core network in a second service network, the method comprising:
receiving user consent preference of a terminal transmitted by a first core network in a first service network, wherein handovers of the terminal are from a first base station in the first service network to a second base station in the second service network, and the user consent preference indicates whether the terminal consents to report terminal location information; and
determining, in response to determining that the user consent preference is not received from the first core network, the user consent preference through other means.

5. The method according to claim 4, wherein determining the user consent preference through other means comprises:
determining whether the user consent preference has been stored; and
determining the user consent preference in response to determining that the user consent preference has been stored.

6. The method according to claim 5, wherein obtaining the user consent preference through other means further comprises:
in response to determining that the user consent preference is not stored, or stored user consent preference is unavailable or expires, obtaining the user consent preference from a unified data management function (UDM) of a home network of the terminal.

7. The method according to claim 6, further comprising:
storing obtained user consent preference; or
updating stored user consent preference according to obtained user consent preference.

8. The method according to claim 6, wherein obtaining the user consent preference from the unified data management function (UDM) of the home network of the terminal comprises:
transmitting an obtaining request to the UDM, wherein the obtaining request is configured to request the UDM to transmit the user consent preference to the second core network; and
receiving the user consent preference transmitted by the UDM.

9. The method according to claim 8, further comprising:
receiving an identifier of the second base station transmitted by the first core network.

10. The method according to claim 4, further comprising:
determining that the user consent preference indicates that the terminal consents to report the terminal location information, and transmitting the user consent preference to the second base station.

11. The method according to claim 10, wherein transmitting the user consent preference to the second base station comprises:
transmitting a handover request to the second base station, wherein the handover request carries the user consent preference.

12. The method according to claim 4, further comprising:
determining that the user consent preference indicates that the terminal does not consent to report the terminal location information, not transmitting the user consent preference to the second base station, or transmitting the user consent preference to the second base station, wherein the user consent preference indicates that the terminal does not consent to report the terminal location information.

13. A method performed by a second base station in a second service network, the method comprising:
receiving user consent preference of a terminal transmitted by a second core network in the second service network, wherein handovers of the terminal are from a first base station in a first service network to the second base station in the second service network, and the user consent preference indicates whether the terminal consents to report terminal location information; and
determining whether to configure the terminal to report terminal location information based on the user consent preference.

14. The method according to claim 13, wherein determining whether to configure the terminal to report the terminal location information based on the user consent preference comprises:
in response to determining that the user consent preference indicates that the terminal consents to report the terminal location information, configuring the terminal to report the terminal location information; and
in response to determining that the user consent preference indicates that the terminal does not consent to report the terminal location information, not configuring the terminal to report the terminal location information.

15. The method according to claim 14, wherein configuring the terminal to report the terminal location information comprises:
transmitting a radio resource control reconfiguration (RRCReconfiguration) message to the terminal, wherein the RRCReconfiguration message carries a configuration for reporting the terminal location information.

16. The method according to claim 13, wherein receiving the user consent preference of the terminal transmitted by the second core network in the second service network comprises:
receiving a handover request transmitted by the second core network, wherein the handover request carries the user consent preference.

17. The method according to claim 13, further comprising:
transmitting configuration information to the terminal, wherein the second base station transmits the configuration information to the terminal in response to determining that the terminal consents to report the terminal location information based on the user consent preference; and
receiving the terminal location information from, the terminal, wherein the terminal location information is determined based on the configuration information.

18-21. (canceled)

22. A communication device, comprising:
one or more processors; and
one or more memories for storing a computer program;
wherein when the computer program when executed by the one or more processors, cause the communication device to act as the first core network and perform the method according to claim 1.

23. A communication device, comprising:
one or more processors; and
one or more memories for storing a computer program;
wherein when the computer program when executed by the one or more processors, causes the communication device to act as the second base station and perform the method according to claim 13.

24. A communication device, comprising:
one or more processors; and
one or more memories for storing a computer program;
wherein when the computer program when executed by the one or more processors, cause the communication to act as the second core network and perform the method is implemented.

25-27. (canceled)
